(19) United States
(12) Patent Application Publication
(10) Pub. No.: US 2009/0072027 A1
(43) Pub. Date: Mar. 19, 2009

(54) Subscription antenna strap

(76) Inventor: Achim Reidelsturz, Wulfrath (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/665,284

(22) PCT Filed: Oct. 15, 2004
(86) PCT No.: PCT/FI04/00615

§ 371 Date: Nov. 19, 2008

(51) Int. Cl. G06K 5/00

(52) U.S. Cl. 235/382

(57) ABSTRACT

An antenna strap for the mobile device is being provided with an antenna extension (means) for receiving wireless broadcast in the mobile device. The antenna extension of the antenna strap extends beyond the traditional antenna of the mobile device so that the mobile broadcast is more feasible and that the antenna strap comprises parameters for initializing an access to the subscribed service delivered by the wireless broadcast. The parameters set the initializing phase for accessing and eventually obtaining at least one subscribed broadcast service.

### CROSS REFERENCE TO RELATED APPLICATIONS

This application is the U.S. National Stage of International Application Number PCT/FI04/000615 filed on Oct. 15, 2004 which was published in English on Apr. 20, 2006 under International Publication Number WO 2006/040389.

### TECHNICAL FIELD OF THE INVENTION

The invention concerns an antenna strap for a mobile. Furthermore, the invention concerns a mobile device for receiving a broadcast service. Yet furthermore, the invention concerns a system for receiving the broadcast service.

### BACKGROUND ART

Digital broadcast has created a great deal of interest as a delivery way. For example, broadcast can offer quite a big data transfer speed, therefore making the system relatively tempting. Environments and situations in the broadcasting systems like digital video broadcasting, which itself has a long history in television and radio even as a digitalised one, have created a need for evaluating the broadcasting technique in a situation where it was not originally designed. An example of this kind of situation can be a mobile reception or more generally a mobile world. Thus, the broadcasting technique is facing the arisen mobility challenge. Because of the complicated and heavy radio-technical nature of the broadcast transmission, an antenna of the mobile device needs to cope with it.

Normally, a broadcast receiver receives all free content that is available. However, some broadcast services require subscription of the service and therefore the receiver should have an enabling conditional access for that particular service or services. This is currently only possible with complicated subscription procedures, by e.g. visiting WEB pages and request there subscription Ids etc. Furthermore, these must be entered manually into the terminal. In the PC world, big and bulky dongles are used for that purpose. However, they are clearly not applicable for being used in mobile world.

### SUMMARY OF THE INVENTION

It is therefore the object of the invention to provide an antenna enabling mobile broadcast reception in the mobile device. Furthermore, the access to the desired, e.g. subscribed, service should be more simple and easy for the user of the mobile device.

In an antenna strap according to the invention the mobile device is being provided with an antenna extension (means) for receiving wireless broadcast in the mobile device. The antenna means of the antenna strap extends beyond the traditional antenna of the mobile device so that the mobile broadcast is more feasible. Furthermore, the antenna strap comprises parameters for initializing an access to the subscribed service delivered by the wireless broadcast. The parameters set the initializing phase for accessing and eventually obtaining at least one subscribed broadcast service. The parameters do not necessarily contain all the necessary parameters for obtaining the broadcast service, but they can relate to the initializing phase. There is no need to additionally enter any parameters etc. Therefore, the user can more comfortably obtain subscribed broadcast services in his mobile device. Thus the antenna strap for the mobile device simplifies the initializing of the access to the service delivered to the mobile device by broadcasting.

A further embodiment of the invention can advantageously utilize a plug-in strap as an antenna for mobile broadcast in mobile devices. Preferably, the further embodiment extends that antenna strap with means for electronic identification of subscribed broadcast services. Thus, the combination of embedded subscription service identification inside electronic antenna straps provides advantageous broadcast service reception way.

In various embodiments of the invention the means for electronic identification of subscribed broadcast services may be many kinds of additional parameters beside the ones to simplify the initialising of the access to the service. For example, the antenna strap can have parameters for receiving alternative frequencies, information about service availability time, and information about service availability geographical position. Furthermore the antenna strap can include information on the tuning parameters of the subscribed broadcast service so that when the strap is attached or plugged into the device, the receiver can tune into that particular channel (or channels). Yet furthermore, the user may be even asked if he wants to be connected to that service when attaching the strap or having attached it to the mobile device.

Further embodiments of the invention have been specified in the dependent claims.

### BRIEF DESCRIPTION OF THE DRAWINGS

The invention will now be described, by way of examples only, with reference to the accompanying drawings, in which:

FIG. 1 depicts an example of a subscription antenna strap coupled with a mobile device according to further embodiments of the invention,

FIG. 2a depicts an example of a knob of an antenna strap containing the parameter for initializing the access to the broadcast service in accordance with various further embodiments of the invention,

FIG. 2b depicts an example of a mobile device for an antenna strap receiving the broadcast service in accordance with various further embodiments of the invention.

### DESCRIPTION OF FURTHER EMBODIMENTS

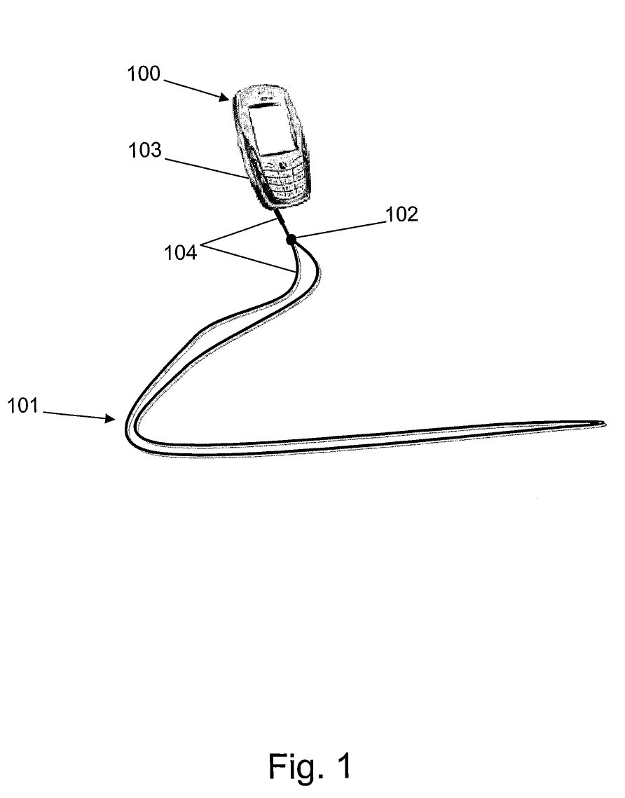

FIG. 1 depicts a concept of a mobile device (100) and the antenna strap (101). The mobile device (100) can be a cellular mobile phone having a capability to receive broadcast transmission such as DVB-H (Digital Video Broadcast for Handheld device), DAB (Digital Audio Broadcasting), DRM (Digital Radio Mondiale), FM-DARC (Data Radio Channel) etc. For enabling broadcast reception in the mobile device (101), a feasible antenna should be available in order to achieve proper reception of the broadcast bearer. The antenna strap (101) can be used for receiving the mobile broadcast transmission. The antenna strap (101) can be a plug-in strap. Furthermore, the antenna strap (101) can be designed for carrying the mobile device (100), and still be used as an antenna. With that antenna and an embedded broadcast receiver, free broadcast content can be received.

Some broadcast services require subscription of the service and enabling the conditional access or the like for that service on the mobile device (100). The antenna strap (101) has a module (102) for electronic identification of subscribed broadcast service(s). With the help of the electric identification module (102), initializing the service access is very much simplified and can be almost invisible to the mobile user. Thus, an embodiment of the invention can provide the combination of embedded subscription service and identification within electronic antenna straps (101). The electronic identification module (102) can be included in a knob (102) of the antenna strap (101).

The embodiment combines the antenna strap (101) with the electronic Identification module, which is built into the antenna strap (101) generally invisibly. In various further embodiments of the invention, with the help of the identification module and an application (103) such as JAVA midlet (103) running on the mobile device (100), a key is derivable. The key can enable the access to conditional access protected broadcast content (i.e. the subscription service) by de-scrambling the data.

For example, a user buying or ordering a particular subscription service may receive the following deliverables:
A plug-in strap (101) as broadcast antenna and carry handle.
A seamlessly embedded electronic identification module (102, 103), which may communicate with the mobile device (101) and give access to one or more subscription services.

The antenna strap (101) may contain conductive wires (104), which operate as an antenna for broadcast receiver of the mobile device (100). The wires (104), or additional, independent and isolated wires can be used for connecting the embedded identification module of the antenna strap (101) with the mobile device (100).

Optionally the communication between the identification module of the antenna strap and the mobile device can be wireless short-range communication. In one embodiment of the invention the identification module of the antenna strap (101) may be a contactlessly readable data carrier, such as a RFID tag and the mobile device (100) is provided with appropriate reading means, e.g. with a RFID reader.

### Various Further Implementations

There are several implementation options for the identification means.
The access key or access key data can be directly located within the antenna strap (101), but only the JAVA midlet (103) can access it. For example, after the antenna strap (101) has been attached to the mobile device (100), the JAVA midlet (103) requests the key from the antenna strap (101). Thereafter, the JAVA midlet (103) obtains the key for conditional access for receiving a service associated with the key.
The access key or corresponding data is directly located within the antenna strap (101), but only the JAVA midlet (103) in combination with the IMSI (International Mobile Subscriber Identity) can access the key. The IMSI can be used to increase the level of security so that the antenna strap (101) can be more user specific. For example, the antenna strap (101) does not give the key if the IMSI is not appropriate. Thereby, the antenna strap (101) having the key is user-specific working only with the appropriate IMSI of the particular user of the mobile device (100).
The key is calculated within the antenna strap (101), on a request by the JAVA midlet (103). This can provide even more security by making it difficult to tamper the de-scrambling key.
The key is calculated within the antenna strap (101), on a request by the JAVA midlet (103), in combination with the IMSI.

Thus the identification module can be placed in the mobile device (100) or inside the attachable knob (102) of the antenna strap (101).

Operating power for the identification module can be supplied over wires (104) in case of wired connection. The operating power may be supplied using electromagnetic waves in case of wireless connection during the ID request-response.

In a further embodiment, the user can advantageously acquire the antenna strap (101) e.g. by buying. The antenna strap (101) (i.e. the broadcast antenna for mobile device) can be acquired as a mobile enhancement product for accessing some digital broadcast services. Thus the user receives thereby the unique subscription key and/or means for accessing certain broadcast service(s). The unique subscription key can be included in the antenna strap (101) as parameters for accessing to the particular service delivered by the wireless broadcast. For example, the key can be electrically embedded into the antenna strap (101).

In a further embodiment, the service delivered by the wireless broadcast can be user-specific. As the strap (101) is a plug-in solution, the access to the service can advantageously move with the user in case of using certain devices for different reasons. For example, the antenna strap (101) can identify the service in various different mobile devices. Thus the particular antenna strap (101) entitles for a particular service, and the strap (101) can operate in different mobile devices (100's).

In a further embodiment, the identification can be advantageously bound to the IMSI (International Mobile Subscriber Identity). If the electronic antenna strap (101) is lost, others cannot abuse it for illegal access to subscribed services. Thus the antenna strap (101) may not work in a mobile device (100), which does not have a particular IMSI etc.

In still further embodiment, an antenna strap (101) can make the reception of the broadcast bearer possible. Thus the antenna strap (101) can have parameters initializing the access for an entire broadcast bearer.

### Various Parameters

In various embodiments of the invention many kinds of additional parameters (102) beside the module (102) for electronic identification of subscribed broadcast services can be applied to simplify the initialising of the access to the service. For example, the antenna strap (101) can have parameters (102) for receiving alternative frequencies, information about service availability time, and information about service availability geographical position. Furthermore the antenna strap (101) can include information on the tuning parameters of the subscribed broadcast service so that when the strap is attached or plugged into the device, the receiver can tune into that particular channel (or channels). Yet furthermore, the user may be even asked if he wants to be connected to that service.

Furthermore the parameters (102) can be at least partly adjustable. For example, a retailer etc. can adjust the parameters (102) in the knob (102) to adapt the parameters to fit for the user's needs or user profile. Thus, content the user wishes to receive and watch in his mobile device (100) or home location can be adjusted.

Still furthermore the parameters (102) can be updated or adjusted via cellular mobile network (e.g. GPRS). For example, once the service access is authenticated the parameters can be reloaded via GPRS.

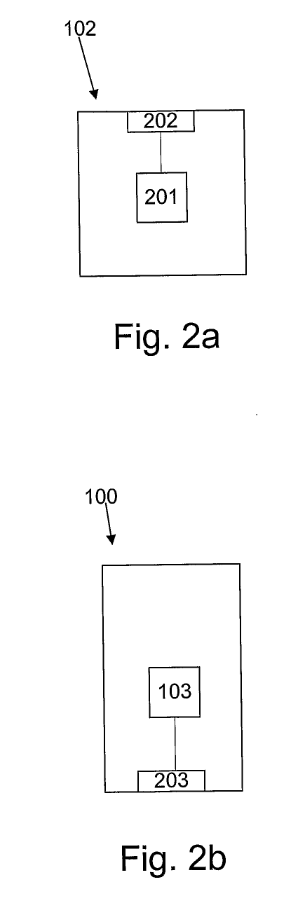

In FIG. 2a there is being depicted the knob (102) of the antenna strap (101) containing one or more parameters (102) for initializing the access to the broadcast service in accordance with various further embodiments of the invention. The knob (102) may contain means (102) for initializing the access to the mobile broadcast service in an electric container (201) such as Flash or EEPROM card or the like. The electric container (201) is coupled with an interface (202) of the knob (102) for interfacing with the mobile device (100).

Also FIG. 2b depicts an interface (203) contained in the mobile device (100) for attaching the antenna strap (101) to the device (100). Also the JAVA midlet (103) is coupled with the interface for communicating with the antenna strap (101). The JAVA midlet can be stored in the memory of the mobile device (100).

### Ramifications and Scope

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the present invention without departing from the spirit or scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An antenna strap for a mobile device, wherein said antenna strap comprises:
an antenna extension for receiving wireless broadcast in the mobile device, and
a module for initializing an access to one or more services delivered by the wireless broadcast.

2. An antenna strap according to claim 1, wherein the antenna strap is adapted to be attached to the mobile device.

3. An antenna strap according to claim 1, wherein the initializing module comprises one or more parameters for simplifying the initializing of the access to one or more of the services.

4. An antenna strap according to claim 3, wherein the one or more parameters comprises data for simplifying the initializing of the access to one or more of the services.

5. An antenna strap according to claim 3, wherein the parameters include information on one or more of the following: transmitting frequency of the service of the wireless broadcast, service availability time of the wireless broadcast, the geographical availability of the service and tuning parameters of the service of the wireless broadcast.

6. An antenna strap according to claim 1, wherein the initializing module comprises a key for decoding coded content of the wireless broadcast.

7. An antenna strap according to claim 6, wherein the mobile device is configured to request the key from the antenna strap.

8. An antenna strap according to claim 6, wherein the mobile device is configured to request the key in combination with an identification of the mobile device.

9. An antenna strap according to claim 8, wherein the identification of the mobile device is an international mobile subscription identity.

10. An antenna strap according to claim 1, wherein the mobile device is configured to send a request for receiving a seed for determining a key for decoding coded content of the wireless broadcast to the antenna strap so that the key is determinable only in the mobile device and the initializing module comprises the seed.

11. An antenna strap according to claim 10, wherein the key is determinable only in combination with an identification of the mobile device.

12. An antenna strap according to claim 1, wherein the service comprises a subscribed service delivered via the wireless broadcast so that the initializing module is adapted to set a key to a conditional access of the mobile device for obtaining the service.

13. An antenna strap according to claim 1, wherein the antenna extension comprises one or more wires for receiving the wireless broadcast and for coupling the initializing module to the mobile device.

14. An antenna strap according to claim 13, wherein the mobile device is carryable by the wires when the antenna strap is plugged in to the mobile device.

15. An antenna strap according to claim 1, wherein a communication between the initializing module and the mobile device is based on a wireless short range communication.

16. An antenna strap according to claim 1, wherein the initializing module comprises a unique user-specific key for decoding coded content of the wireless broadcast so that the key is operable only with a corresponding identification of a user of the mobile device.

17. A mobile device for receiving a service delivered by mobile broadcast, wherein the mobile device comprises:
an application for communicating with an antenna strap, the antenna strap being adapted to be attached to the mobile device, so that one or more parameters for initializing an access to the service is receivable from the antenna strap at the application.

18. A system for receiving a wireless broadcast service, wherein said system comprises:
a mobile device comprising an application for coupling with an antenna strap; and
the antenna strap for receiving wireless broadcast in the mobile device,
the antenna strap further comprising one or more parameters for communicating with said application for initializing an access to one or more services delivered by the wireless broadcast.

19. An antenna strap for a mobile device, comprising:
means for receiving wireless broadcast in the mobile device, and
means for initializing an access to one or more services delivered by the wireless broadcast.

20. An antenna strap according to claim 19, wherein the means for initializing the access comprises one or more parameters for simplifying the initializing of the access to one or more of the services.
